(19) United States
(12) Patent Application Publication
(10) Pub. No.: US 2017/0032470 A1
(43) Pub. Date: Feb. 2, 2017

(54) GROUP COLLABORATION SOCIAL MEDIA PLATFORM

(71) Applicant: Investor's Forum, Bangkok (TH)

(72) Inventor: SUSORNPOL WATANACHOTE, Bangkok (TH)

(73) Assignee: Investor's Forum, Bangkok (TH)

(21) Appl. No.: 14/810,260

(22) Filed: Jul. 27, 2015

(51) Int. Cl. G06Q 50/00; G06Q 30/02; G06Q 10/06; G06Q 40/06

(52) U.S. Cl. CPC G06Q 50/01; G06Q 40/06; G06Q 30/0201; G06Q 10/067

(57) ABSTRACT

A method for managing dynamic models in a social media platform includes creating a shared collection of comparable, dynamic models dedicated to a subject in the social media platform based on instructions from a first group member. The social media platform includes a subset of interactive webpages dedicated to at least one of the comparable, dynamic models and a database containing at least one model profile of the comparable, dynamic models. The method also includes creating a group of members that includes the first group member who have access to the shared collection, assigning at least one member of the group other than the first group member a permission to modify the shared collection, and updating the comparable, dynamic models by changing the associated model profile in the database in response to receiving modifying instructions from the at least one member.

### BACKGROUND

Social networks have a tremendous impact on our everyday lives. Many people are using social networks to connect themselves to their friends, their community, and the world. Typically, social media platforms or social messaging platforms are generally developed to loosely share information generated from individual users with a lot of people. This shared information is often archived based on the time that the information was posted. Some social platforms provide related keywords for categorizing shared information with similar topics. With these social media platforms, it is difficult for users to discuss multiple subjects in a manner that is convenient for archiving. For instances, group discussions that include both a stock portfolio and a list of real estate may be difficult for archiving because the shared information covers multiple topics.

There are other types of social networks that accommodate group discussion dedicated to specific topics. For example, these social networks include social book marking sites, social catalogs, social photo albums, social voting, social ranks, and so on. These social media platforms also have difficulties organizing shared information that includes multiple subjects. These platforms lack flexibility for other users besides the creator of the content to add more information. Also, when the content in this social networks involves subjects that are frequently outdated, updates must be done manually by the content's creator. If users are to make the updates manually, some platforms do not have specialized group permissions to allow users to collaborate in modifying the list. Thus, only the creators or the administrators can modify the group information.

Additionally, traditional social network chat room suffers from a lack of flexibility and adaptability. These chat rooms are developed for one on one or single stream conversations. But, these chat rooms are used by multiple users, and all the messages are sorted based on the time of posting. Whenever multiple users create and use the same chat room, some users will be left behind because topics keep changing. So, there is a need for a chat room that can support multiple streams of conversations simultaneously.

### SUMMARY

Embodiments of the present invention provide systems and methods for a group discussion about a collection of subjects in a social media platform. The social media platform includes a shared collection, which includes a collection of comparable, dynamic models. Each of these models can be displayed in interactive webpages of the social media platform and associated with a dedicated model profile stored in database. As changes are made to the model profile in the database, the changes are reflected in the interactive webpages. Thus, the information about a model will be consistent in the database and in the interactive webpages. The models may correspond to an entity, a person, a place, an organization, another tangible subject, a quality, a stock, a community, an event, an idea, a commercial product, a professional service, or an attraction. Each of the models may be associated with a name, a subject, a dedicated webpage, keywords, a description, related links, images, news, prices, users who contribute information about that model, and so on. Each shared collection is dedicated to a single subject, and each of the models in the shared collection are part of that subject. Thus, each of the models are comparable to one another. The interactive webpage for each model enable users to easily share their opinions, information, experience, or reviews of the corresponding subject. Certain information about the models can be updated automatically such as stock prices or financial result of the organization and so on. Other types of information about the models may be updated manually by any member of the group who has permissions to make changes.

In one aspect of the invention, a method for managing dynamic models in a social media platform includes creating a shared collection of comparable, dynamic models dedicated to a subject in the social media platform based on instructions from a first group member. The social media platform includes a subset of interactive webpages dedicated to at least one of the comparable, dynamic models and a database containing at least one model profile of the comparable dynamic model. The method also includes creating a group of members that includes the first group member who have access to the shared collection, assigning at least one member of the group other than the first group member a permission to modify the shared collection, and updating the comparable, dynamic model by changing the associated model profile in the data in response to receiving modifying instructions from the member.

In some cases, the comparable, dynamic models are financial assets, commercial products, services, or other types of comparable item. The permission may include an ability to create a new model profile in the database through the subset of interactive webpages, an ability to edit the associated model profile in the database through the subset of interactive webpages, an ability to remove an existing model profile from the shared collection, an ability to annotate an existing model within the collection.

In some examples, the method include withholding the permission from another member of the group. The method may also include determining to assign at least one member of the group a permission to modify based on at least one criteria. The criteria may include a family relationship identified in the user profile, a degree of separation relationship identified in the user profile, an organization membership relationship identified in the user profile, or another type of criteria.

The method may also include granting access to private information in the shared collection to a designated member so that the designated member has an ability to view the private information while non-designated members have just access to public information in the shared collection. Further, the method may include sharing the shared collection publically so that non-members have access to public information in the shared collection while at least designated members of the group have access to public information and private information.

In another aspect of the invention, a system may include a social media platform that includes group members, each of the group members having a user profile. The social media platform also includes a shared collection of comparable, dynamic models dedicated to a subject. The shared collection has a subset of interactive webpages dedicated to at least one of the comparable, dynamic models. The system also includes a database containing a model profile for the at least one of the comparable, dynamic models that is linked to the interactive webpages. Updates to the model profile are reflected in the interactive webpages.

In another aspect of the invention, a system includes a social media platform, the social media platform has group members, each of the group members having a user profile. The social media platform also includes a shared collection of comparable, dynamic financial assets dedicated to a subject where the shared collection is created by a first member of the group members. The shared collection has a subset of interactive webpages dedicated to at least one of the comparable, dynamic financial asset. The system also includes a database containing a model profile for the at least one of the comparable, dynamic model that is linked to the subset of webpages. Updates to the model profile are reflected in the subset of interactive webpages. Other group members in addition to the first member have an ability to send modifying instructions to update the model profile, to create a new model profile, and to remove the model profile.

In another aspect of the invention, a chat room discussion method for branching conversation streams includes receiving an initial post, storing the initial post as part of a first conversation stream, receiving a subsequent chat, determining that the subsequent chat has a different topic than the first conversation stream, and storing the subsequent chat as part of a second conversation stream.

In some examples, the first conversation stream is dedicated to a first topic and the second conversation stream is dedicated to a second topic. The method may also include identifying either of the first topic or the second topic based on a selection of a button. The method further includes identifying either of the first topic or the second topic based on key word recognition included in the subsequent chat. The method may also include receiving a search query involving the second topic and presenting the second conversation stream without the first conversation stream.

The method may include receiving a third chat on a third topic and storing the third chat as part of a third conversation stream based on the third topic. The method further includes creating a second conversation stream and presenting the subsequent chat as the initial post in the second conversation stream. The method may include inviting chat room participants of the first conversation stream to the second conversation stream.

The first conversation stream and the second conversation stream may be presented in the same page. The first conversation stream and the second conversation stream may be displayed in the same page. The first conversation stream and the second conversation stream may remain open simultaneously with either the first conversation stream or the second conversation stream overlaid over the other. Storing the subsequent chat as part of the second conversation stream may be in response to a user command.

In another aspect of the invention, a chat room computing device for branching conversation streams includes a memory and processor where the memory includes programmed instructions to cause the processor to receive an initial post based on a first topic, add the initial post in a first conversation stream, receive a subsequent chat based on a second topic, store the subsequent chat as part of a second conversation stream based on the second topic, identify either of the first topic or the second topic based on a selection of a button, receive a search query involving the second topic, and present the second conversation stream without the first conversation stream in response to the search query.

In another aspect of the invention, a computer-program product for branching conversation streams has a non-transitory computer-readable medium having instructions thereon. The instructions being executable by a processor to receive an initial post based on a first topic, add the initial post in a first conversation stream, receive a subsequent chat based on a second topic identified based on the selection of a button, store the subsequent chat as part of a conversation stream based on the second topic, receive a search query involving the second topic, present the second conversation stream without the first conversation stream, invite chat room participants of the first conversation stream to the second conversation stream, and present the first conversation stream and the second conversation stream simultaneously.

Additional objects, advantages, and novel features of the examples will be set forth in part in the description, which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

A further understanding of the nature and advantages of the embodiments may be realized by reference to the following drawings. In the appended figures, similar components or features may have the same reference label.

FIG. 1 is a block diagram of an example of an environment in which the present systems and methods may be implemented.

FIG. 2 is a diagram of an example of a user interface depicting a shared collection according to the principles described in the present disclosure.

FIG. 3 is a diagram of an example of a user interface depicting a shared collection according to the principles described in the present disclosure.

FIG. 4 is a diagram of an example of a user interface depicting a shared collection according to the principles described in the present disclosure.

FIG. 5 is a diagram of an example of a user interface depicting a shared collection according to the principles described in the present disclosure.

FIG. 6 is a diagram of an example of a user interface depicting a multidimensional chat according to the principles described in the present disclosure.

FIG. 7 is a diagram of an example of a user interface depicting a time line viewing mode according to the principles described in the present disclosure.

FIG. 8 is a diagram of an example of a user interface depicting a multidimensional chat according to the principles described in the present disclosure.

FIG. 9 is a block diagram of an example of a time line according to the principles described in the present disclosure.

FIG. 10 is a block diagram of an example of a computing device according to the principles described in the present disclosure.

FIG. 11 is a block diagram of an example of a shared collection module according to the principles described in the present disclosure.

FIG. 12 is a block diagram of an example of a chat room module according to the principles described in the present disclosure.

FIG. 13 is a block diagram of an example of a permissions module according to the principles described in the present disclosure.

FIG. 14 is a flow diagram illustrating an example of a method for managing dynamic models in a social media platform accordance to the principles described in the present disclosure.

FIG. 15 is a flow diagram illustrating an example of a chat room discussion method for branching conversation stream accordance to the principles described in the present disclosure.

FIG. 16 is a flow diagram illustrating an example of a chat room discussion method for branching conversation stream accordance to the principles described in the present disclosure.

FIG. 17 is a block diagram of an example of a computer system suitable for implementing the present systems and methods.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

The present systems, methods, and devices described herein relate to an online social network service that accommodates any desired number of users that can communicate with each other in real-time or near real-time. Such users can stay up to date with their friends by sharing information about their activities and interests. More particularly, the present systems, methods, and devices relate to providing users with a shared collection of comparable models within a social media platform where users with different level of permissions can modulate or update the information and share activities with others with social media platform.

Conventionally, social media platforms loosely share information generated from users in social media. Some platforms categorize information by keywords so that related subject can be organized. But, these categorization system do not prevent a user from discussing multiple topics under one classification. Therefore, the social media conversations can become unfocused which makes searching through a social media platform for specific topics cumbersome.

Further, discussions pertaining to dynamic information are difficult to discuss when the information is inconsistently or infrequently updated across the social media platform. For example, as the information changes the chats made by the users may be based upon outdated information. Examples of lists that might be difficult to discuss when information is not consistently updated includes best stock picks, best technology stocks, best digital cameras, riches entrepreneurs, best graduated schools, best ophthalmologists, best places to visit, best companies to work for, and the like.

The principles described herein include a social media platform that includes multiple modules. Such modules may include a shared collection module, model profile module, a social messaging module, a social wall module, an activities streams model (for individual or a group), a chat room module, a social bookmarking module, a social ticker module, a user profile module, a group profile module, other modules, or combinations thereof. The modules can be controlled by multiple users with various levels of permissions. The permissions may allow different users to participate through the social media platforms at different levels. For example, some users may an ability to view, edit, remove, and create models, while other participants can only do a subset of these functions. For instance, the shared collection may be editable by a single user only. An example where it may be desirable to have a single user with an ability to edit the shared collection or just one of the models includes when an analysts or trader shares a user's stock portfolio with the public for reporting purposes. Thus, the collection may be shared with the public for viewing, but not for collaborating. On the other hand, other users with a greater amount of permissions may edit the information in the stock portfolio through the same social media platform through which the public has access.

Additionally, traditional social network chat rooms or messaging systems suffers from a lack of flexibility and adaptability. For example, the chats in conventional chat rooms are only organized based on time of entry. Thus, following a chat conversation may become confusing because topics keep changing. So, there is a need for a chat room that can support multiple conversations topics simultaneously.

As used herein, the term “module” includes a combination of hardware and programmed instructions that are necessary for performing the designated function of the module. Components of the modules may be located on the same physical device or some of the components may be located at remote locations that are in communication with the other components of the module.

As used herein, the term “social media” generally refers to a concept that an individual's personal network of friends, family colleagues, coworkers, and the subsequent connections within those networks, can be used to find more relevant connections for a variety of activities, including, but not limited to financial activities, moods, status of activities like buying or selling reports, networking, content sharing, discussing, teaching, strategy planning, recommending, like-minded individuals, activity partners, or the like. Thus, the term “social media” refers to a platform where multiple users contribute the content to the webpages.

The term “shared collection” generally refers to a group of comparable, dynamic models that belong in the same subject.

The term “model” refers to an item belonging to a share collection that has a model profile in a database and the model is displayed in the interactive webpages of the social media platform. A “model” may refer to a financial asset, a commercial product, a service, an attraction, another type of item, or combinations thereof.

A “model profile” refers to metadata that describes the model and is stored in a centralized database. The “model profile” contains the most up-to-date version of the model so that all references to the model throughout the social media platform are consistent with what is contained in the model profile.

The term “shared” generally means that the modules can have multiple owners, creators, editors, and contributors.

The term “comparable” generally refers to items that can be compared to like items. For example, a social collection with a subject of companies may include a list of companies. Each of the companies can be compared to each other.

The term “dynamic” generally refers to a model having a likelihood of changing over time. Company stocks are dynamic because the stocks change frequently during trading hours every day. But, a restaurant is also considered to be dynamic because menus change, locations change, and other features of the restaurant change, although such changes occur over a longer period of time. In the case of the restaurant, the changes may occur over a period of years.

The term “interactive webpages” generally refers to social media webpages where users can add content to the social collections. For example, the user may create a model profile through the interactive webpages although the profile will be stored in a separate database. Likewise, a user may modify the model profile, update the model profile, annotate a model profile, comment on a model, like a model, create a social collection, assign a subject to a social collection, assign group members permissions, or otherwise interact with the social media platform. The “interactive webpages” may be the front end of the social media platform.

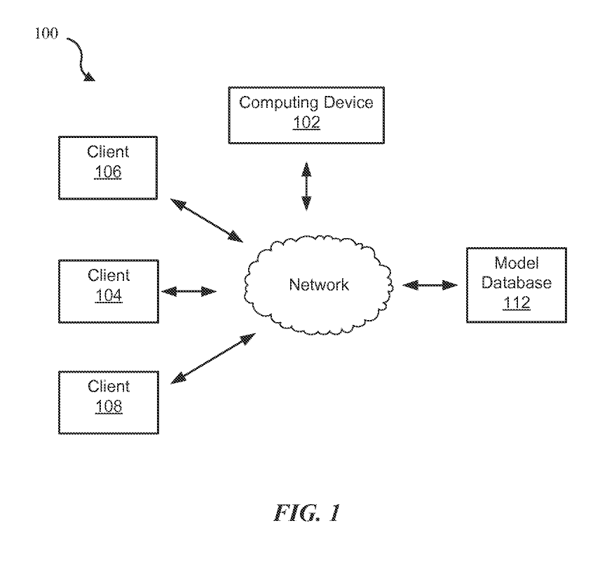

The term “permission” generally refers to users having multiple levels of abilities to create, update, view, remove, edit, or otherwise interact with the shared collection or the models in the shared collection. FIG. 1 is a block diagram depicting one embodiment of an environment 100 in which the present systems and methods may be implemented. In some embodiments, the environment 100 includes a computing device 102, a model database 112, and multiple client devices 104, 106, 108. The computing device 102 may be in communication with the client devices 104, 106, 108 through any appropriate network 110. In some examples, a wireless network is used to communicate between the computing device 102 and the client devices 104, 106, 108. Examples of networks that may be used include, but are not limited to local area networks (LAN), wide area networks (WAN), virtual private networks (VPN), wireless networks (using 802.11, for example), and/or cellular networks (using 3G and/or LTE, for example), Bluetooth networks, z-wave networks, other types of networks, or combinations thereof. In other examples, the computing device 102 is in hardwired communication with at least one of the client devices 104, 106, 108.

Any appropriate type of client device 104, 106, 108 may be used in accordance with the principles described herein. For example, at least one of the client devices 104, 106, 108 may be a smart phone, an electronic tablet, a laptop, another type of mobile device, a desktop, a personal computer, a wearable device, smart glasses, a watch, touch screen, or combinations thereof. In some embodiments, at least one of the client devices 104, 106, 108 is a mobile device that is a portable with a touch screen display.

The computing device 102 may host the social media platform. For example, an online financial social media platform typically includes a user's set of direct and/or indirect personal relationships, including real and virtual privileges and permissions that users may associate with these other users. Direct personal relationships usually include relationships with people the user can communicate with directly, including family members, friends, colleagues, coworkers, and other people with which the person has had some form of direct contact, such as contact by telephone, by email, by instant message, or the like. These direct personal relationships are sometimes referred to as first-degree relationships. First-degree relationships can have varying degrees of closeness, trust, and other characteristics.

Indirect personal relationships typically include relationships through first-degree relationships to people with whom a person has not had some form of direct or limited direct contact, such as a friend of a friend represents an indirect personal relationship. A more extended, indirect relationship might be a friend of a friend of a friend. These indirect relationships are sometimes characterized by a degree of separation between the people.

The model database 112 stores model profiles. The model profiles may include an entity, a person, a place, an organization, another tangible item, a quality, a stock, a financial asset, a financial product, an investment, a community, a professional service, a commodity, an attraction, an event, or an idea. The profiles may include names of model, types of the subject, dedicated webpage, keywords, description, related links, images, news, prices, users who contribute information for the subject, and so on.

Some model profiles can be updated automatically using software instructions. For instances, stock prices, news feeds, company financial reports, and so on may automatically update the model profiles. Other model profiles can be updated by users in the social network through the interactive webpage. For instances, the manual updates may include adding related links, reviews, comments, likes, and so on.

Users may send instructions to the computing device 102 through the client devices 104, 106, 108. Such instructions may include commands to update the model profiles in the database. For example, a user may send an instruction to the computing device 102 to create a new shared collection and designate a subject for the shared collection. For example, the new shared collection may be a shared stock portfolio and the collection subject is a stock. Therefore, the comparable, dynamic models for this shared collection are individual stocks. No other types of models are added. The user can create a name for the shared collection. As a result, the computing device 102 may create the shared collection and give permissions to the users associated with client device 104 to view, edit, update, and remove shared collection and associated models. The user associated with client device 106 may also have permission to view, edit, update, and remove the shared collection or the associated model profiles created by user associated with client device 104. But, the user associated with client device 108 may have less permissions and therefore only has the ability to perform less functions with the shared collections and/or the model profiles. For example, the user associated with client device 108 may only have the ability to view the shared collection, but not the ability to edit, update, or remove the shared collection or the models.

The level of permissions that each user receives may be based on instructions from the creator of the shared collection. In other examples, the level of permission assigned to each user is based on a relationship with the user who created the shared collection. In one instances, the users associated with client devices 104, 106 are a married couple and the subject of the shared collection is the couple's financial assets. In that situation, the husband and wife may post their shared collection on the social media platform so that they both have easy access to it. The husband and wife can discuss concerns and trends about their shared collection. In cases where the husband created the shared collection, the wife may update or change the shared collection at a later time, such as when the couple's financial situation changes. The user associated with client device 108 may be a relative, a named executor of estate in a testamentary will, a financial advisor, a child, or another person that the couple trusts with their shared collection, but does not want to have the ability to edit, update, or remove the models in the shared collection.

In another situation, the users associated with the client devices 104, 106 are business partners and the subject of the shared collection is their company's assets. Thus, just the assets jointly owned by the partners are added to the shared collection. No other types of model should be added to the shared collection. Each of the partners can update the shared collection. In the view of the shared collection available to the partners, the partners can view public information about their startups, loans, investments, real estate, or types of information commonly owned by them, and so forth. Some of the models may be available to the public, such as information that is required for reporting to various government agencies. But, the partners can also view private information, such as amount of money invested in each startup, the names of the investments, and the amount in their investments. The user associated with client device 108 may not have access to update the shared collection and also not have access to view the private information.

In some cases, the social media platform's information includes various profile information about a member, including, but not limited to the member's avatar, banner, moods, contact information, the member's preferences, degrees of separation between the member and another member, a membership to various modules, or groups, or the like. Together, these types of information form the user's profile or the group's profile.

User of a financial social media platform can create multiple social groups, clubs, fan pages, organization groups, and the like. These groups can be treated as similar entities as though they were a single user. A group can have multiple members, and members may have different set of permissions to update activities in the group. A group can provide its own shared financial modules for its members, where the members can help update information or activities in the modules.

A financial module is a unit or a subset of a financial software platform that displays and reports financial/non-financial information. According to one embodiment, a shared financial module may incorporate multiple levels of user permissions to access the module. Permissions may include a create permission, a view permission, an edit permission, an access permission, or a remove permission. Sometimes the permissions are granted by default based on social networking information. Various permissions for access may be associated with at least some of the social networking information. Some access permissions may be selected, for example, based in part, on an input by the member, while other access permissions may be defaulted based on other events, constraints, or the like.

Moreover, the shared collaboration module may display a report of activities or users' activities based on importance, degree of separation, social relation, time, and the like. Therefore, for each user, the report of activities are likely to be different from user to user. In other words, a report for a specific user can be customized based on different desirable factors to the user. For instance, certain activities that are deemed desirable to the user may be displayed first in a list so that the most desirable activities are brought to the user's attention more quickly. For instance, the degree of separation may determine the importance of certain activities which would be displayed first in the list for the user. In such an example, the activities of users with the public relationship would be considered may be less desirable for the user, and thus these activities may be posted below other activities deemed more interesting to the user. Thus, the user may cause the user to scroll down further to see such an activity or involve further actions to view full a list of such activities.

Additionally, the present system may use other users' social information, such as number of friends, number of likes, expertise levels, group roles, statuses, and the like to further organize the report of social activities. Each particular shared collection module user interface may report or display social activities differently.

According to one embodiment, the social media platform provides a financial module and a shared collection. The shared collection may be referred to as a watch list or a favorite list. No other types of model that are outside of the specific subject of the lists should be added to this shared collection. A shared collection may be a real investment tracking which includes private information such as gain, lost, cost basis, and level of cash of a user. The shared collection of this type can often be downloadable or be automatically synchronized from brokers into the modules. Although this information can be private and sensitive, the information can still be shared and socialized among trusted users. For instance, the information can be shared between family members (e.g. between a husband and a wife). While, for instance, favorite lists, which are less private matters, are more suitable to shared or socialize for social discussion among user groups or even the public.

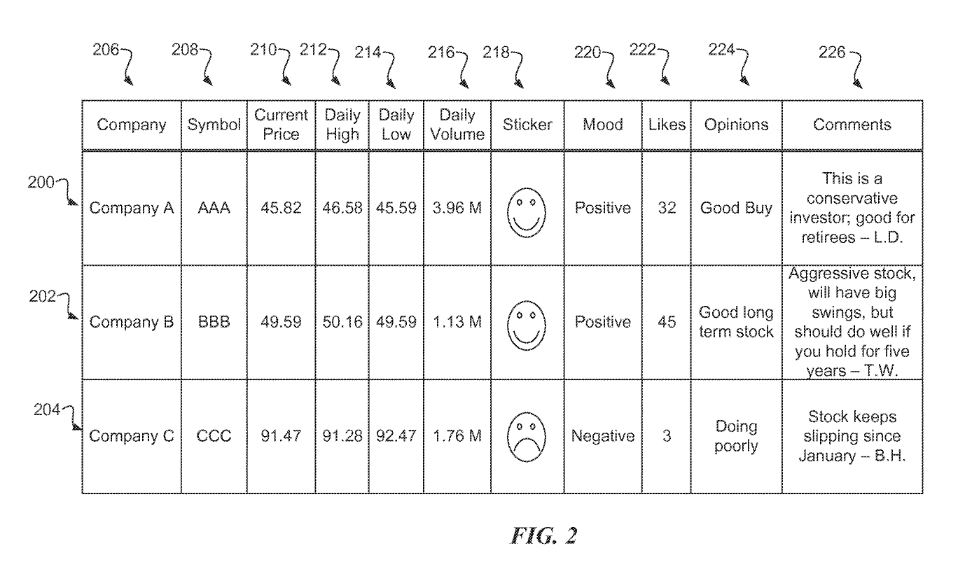

A shared collection includes comparable models of the same types, and a set of users' permissions for updating the shared collection. A comparable model may be presented in the interactive webpages as a row, a block, a stack, a folder, or another format. Each model includes multiple profiles that describe the corresponding details of the model. For instance, a shared collection dedicated to stocks includes a collection of stocks. In the example of FIG. 2, the shared collection organizes the models in row form. In this instance, the models include financial information. A non-exhaustive list of information that may be contained in a model for a stock includes a name of the stock, the current price, the daily high, the daily low, the daily volume, and notes about the stock. The model profiles may also include information associated with the stock such as stickers, moods, likes, opinions, comments, notes, and many more. Additionally, social information can be a summary of participants' activities, multiple users' mood, popularities of stocks, and the like. When a user changes or edits information on a shared collection, a social alert or notification to other participating group members may be generated. For instances, a notification may be sent in response to a user adding new stock, commenting the shared collection, adding a target price to a stock, adding a happy sticker, performing another type of event, or combinations thereof. The social alert can be automatically created. For example, a social alert may be generated when certain conditions are met, such as when the price of a stock is up 10.0% or there is an unusual volume change in a stock, other conditions, or combinations thereof.

Only the same type of models are included in the shared collection. In an example where the subject of the shared collection is investments, users of the social media platform can create an investment recommendation model associated with a stock and then add the model into the shared collection. In this particular embodiment, the investment recommendation model profile includes recommendations selecting an action to take with the stock like buying, selling, watching, and holding; writing the reason for choosing such action; inserting optional information such as images, URL links; and the like.

In the illustrated example, a first model 200 is depicted in a first row, a second model 202 is depicted in a second row, and a third model 204 is depicted in a third row. A different kind of information from the model profiles is depicted in the columns. In the illustrated example, a company name 206 is depicted in a first column, a company symbol 208 is depicted is a second column, a current price 210 is depicted in a third column, a daily high 212 is depicted in a fourth column, a daily low 214 is depicted in a fifth column, a daily volume 216 is depicted in a sixth column, a sticker 218 is depicted in a seventh column, a mood 220 is depicted in an eighth column, a like count 222 is depicted in a ninth column, opinions 224 are depicted in a tenth column, and comments 226 are depicted in an eleventh column. In some examples, the opinions 224 are posted by users or professional organizations that track stocks. Such information may be pulled from the websites of those organizations and presented in the social media platform depicted in FIG. 2. In some examples, the comments 226 may be added by those participants who have permissions to annotate the shared collection.

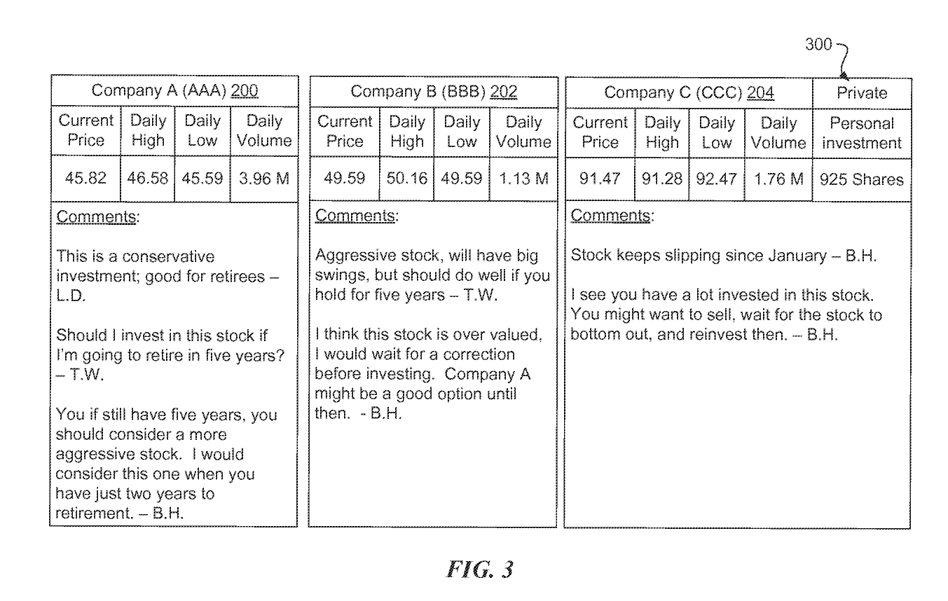

FIG. 3 shows a shared collection with models 200, 202, 204 in block form. In some cases, the blocks depict less information than is depicted in the rows of FIG. 2. But, the blocks may include more or less information than is depicted in the row format. The size of the block can be varied and can be in any shape or form. In this example, private information 300 is depicted in the model 204. This information includes the amount of shares that the group member has in Company C. In this example, just those group members who have the proper permissions can view such private information, while the other group members cannot view the private information.

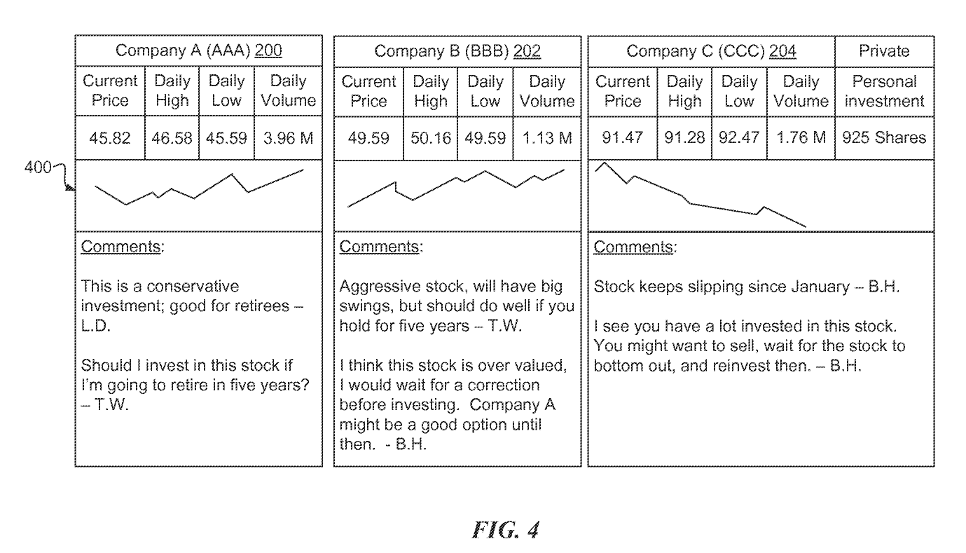

Additionally, FIG. 4 shows models in block form that may also be incorporated with stock charts 400.

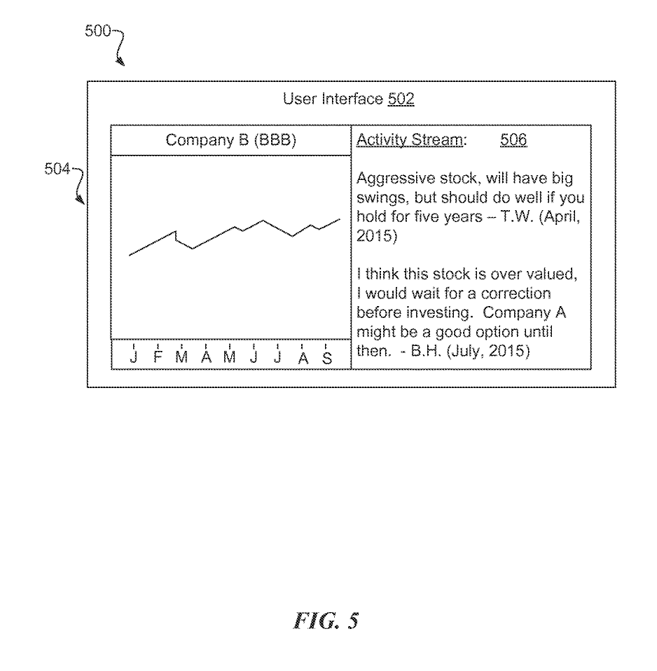

FIG. 5 illustrates an embodiment of a social activities page 500 depicted in a user interface 502 associated with particular model 504. Such a social activity page may be part of the interactive webpages. In some cases, a social notification sent for an event is depicted in the activity stream 506. Social activities may be grouped based on importance or based on social information such as degree of separation for the convenience of the user.

While the examples above have been described with reference to particular formats in which the shared collections may be presented, the shared collections may be presented in any appropriate format. Further, the comparable models included in the shared collection may include more or less information than in those examples depicted above. Further, the examples depicted above are dedicated to presenting a stock portfolio, but the comparable models may include other types of information in addition to financial information or in lieu of financial information. For example, the comparable models may be of different discussion topics, best travel places, best recipe/cooking, projects, best management styles, best schools, other types of topics, or combinations thereof.

In the present invention, a user can create any number of shared collections. Such shared collections may be shared among a group of users. In some circumstances, the user that creates the shared collection (i.e. first group member) may invite others to the shared collection. In other examples, everyone in the user's social network may be automatically invited to join the shared collection. In yet other examples, just certain individuals within a user's social network are invited to the shared collection. For instance, just those who are only one degree removed from the user may be invited to participate at some level in the shared collection.

Further, the user who creates the shared collection may manually set permissions for others invited to collaborate in the shared collection. In other examples, the permissions are automatically generated based on relationships with the user. For example, close family members, business partners, board members, or other types of individuals with certain relationships with the user may automatically receive a set of permissions when the user creates a shared collection. In other cases, the permissions are initially set with automatic defaults, but the user has an option to manually change these permissions before sending the invites to the group.

With proper permission, a user may copy, create, or share the shared collection to a group. In some cases, if a group is invited to a shared collection, the members of that group can see the shared collection, but cannot edit the shared collection. In such an example, if the user creates a shared collection for a group, that member of the group may participate in editing and updating the shared collection.

In some cases, a user may connect an application program interface (API) to the social media platform. This API may be used to update the model profiles automatically or perform other functions. For instances, an API may be used to create a real-time scan list, an alert list, another list, or combinations thereof.

In conventional social websites, a portfolio can be shared to a social network. But, such a portfolio can only be edited by the user who posts the portfolio and cannot be edited by other members. In these conventional social websites, others in social websites can receive and follow comments from other users, but they cannot edit or remove components in the portfolio. Thus, without the shared collection module, the conventional social websites are like a mere financial report from a broker. Allowing group members to do more than just view information in the shared collection, such as edit, remove, annotate, and perform other tasks related to updating, improving, and maintaining the shared collection, the present invention solves problems for social media platforms. All comparable models in the shared collection are associated with model profiles in the database. So, information about the model are organized and up-to-date. This is especially the case where private information is being shared and is allowed to be edited, updated, improved, or maintained by other group members. In this present invention, a group can agree on an objective strategy or a goal, and then the group members can collaborate together to update the shared collection based on the agreed upon goals and objectives.

A stock ticker is a module that displays a stream of stock names and associated information. The source of stock names are normally stocks that were recently traded and are received through data feeds from stock exchanges. Other sources are stocks that were recently mentioned in social tweets, micro blogs, blogs, news, other sources, or combinations thereof. This market ticker may be incorporated into the social media platform to provide updates to the model profiles.

According to an embodiment of the present invention, additional sources of stock names are obtained by recording or forwarding activities involving stock researched by one of the group members and redistributed in real time or near-real time to other users. The activities of a group member may be recently requested stocks in chart module, or recently added stocks into a portfolio, and the like. The stock tickers may be displayed to a first group member to suggest the inclusion of a particular stock or other type of information be included in the shared collection. The stock tickers may be incorporated in other financial modules such as charts or portfolios. At least one benefit of having stock tickers is frequent and automatic updates. Thus, the group member contributing content to the portfolio does not have to wait for stock trading results or receive a tweet from a contact about a certain stock. Such stock tickers may be sourced from public activities, from within a group or multiple groups, from friends or list of friends, or the like. The list of stock names in a social ticker may be filtered according to user profiles or user preferences, or filtered by stock name, filtered by other criteria, or combinations thereof.

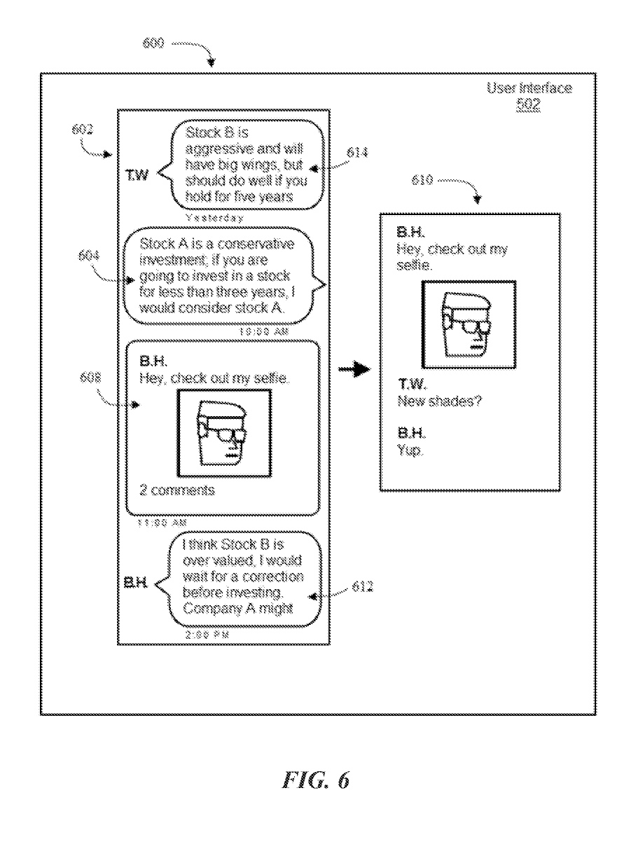

FIG. 6 depicts examples of a multi-dimensional chat system. Conventional room chat systems allow users to communicate in real time or near-real time over a network. A chat room allows multiple users to communicate synchronously and privately within the confines of the chat room and the member of the room. The user interactions in such a conventional chat room systems includes entering a particular chat room as an active user to type in messages and/or view messages and responding to messages in a chat room displayed during a chat session. In situations where the conversation between members of the group are interrupted by having other members initiate new questions or new topics into the conversation stream, the chats become hard to follow and search. This may causes group members difficulty when referring back to certain topics.

For the purposes of this disclosure, the term “chat” is a text message or other digital entity created by a user. In conventional chat room systems, a chat cannot be distinguished from other types of chats. For example, a chat may be a new topic or reply messages, but the conventional social website cannot distinguish between the two. But, according to the principles described herein, the social platform can distinguish between chats and posts. For the purposes of this disclosure, a “post” generally refers to a text message or other digital entity created by a user for initiating a new conversation stream or new topic. A post is commonly used in a social wall or social time line. A user may initiate a new topic by creating a new post, other users may reply to it with a chat.

FIG. 6 illustrates one example of a multidimensional chat room system 600 where a user receives the chats or the posts that originate from another group member or a remote user in conversation stream 602 organized in a descending order of the posting's time. Chats 604 and posts 608 are different software interfaces. In particularly, with the post 608, the chat room users are invited to another conversation stream 610, so users can continue the discussion without interrupting the conversation in already in conversation stream 602.

According to an example embodiment, a user of the chat room may respond to the conversation stream 610. The new conversation stream or the new post can be created and inserted just below the corresponding conversation stream. According to an example embodiment, whenever a post is created, the chats above the new post are grouped into a topic. A new chat created just below a post may be automatically considered as a new topic. In the example of FIG. 6, the conversation stream is in a multidimensional chat room viewing mode. With this new ability to separate chats into topics, the chat room may be turned into a time line viewing mode or social wall viewing mode.

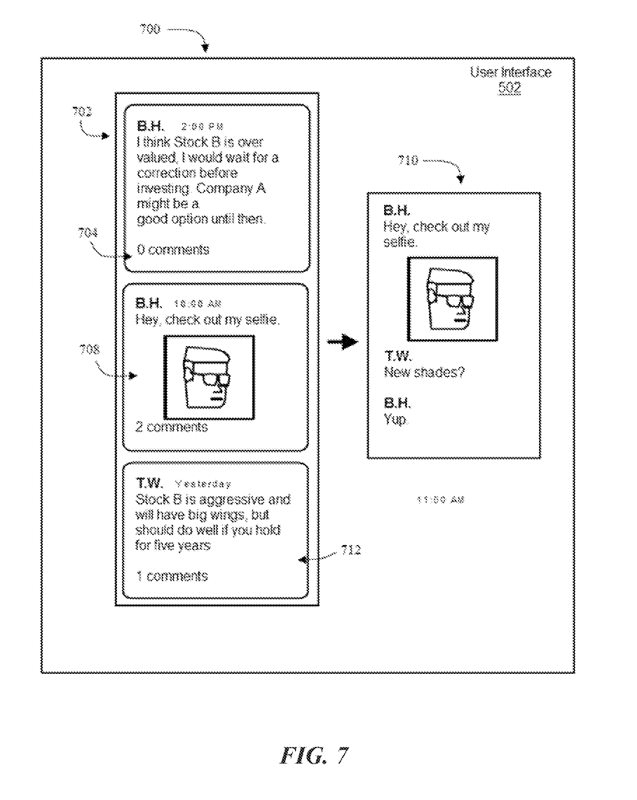

FIG. 7 illustrates a conversation stream 702 in time line viewing mode 700. The time line thread shows topics organized in ascending order based on time of posting. In the first line thread, chats 704, 708, 712 are ordered in ascending chronological order. But, with the creation of chat 708, the conversation stream branches. In this instance, the users are invited to a new conversation stream 710 in full conversation view. As used herein, the term “branch” refers to a new conversation stream breaking off of another conversation stream in response to a topic change.

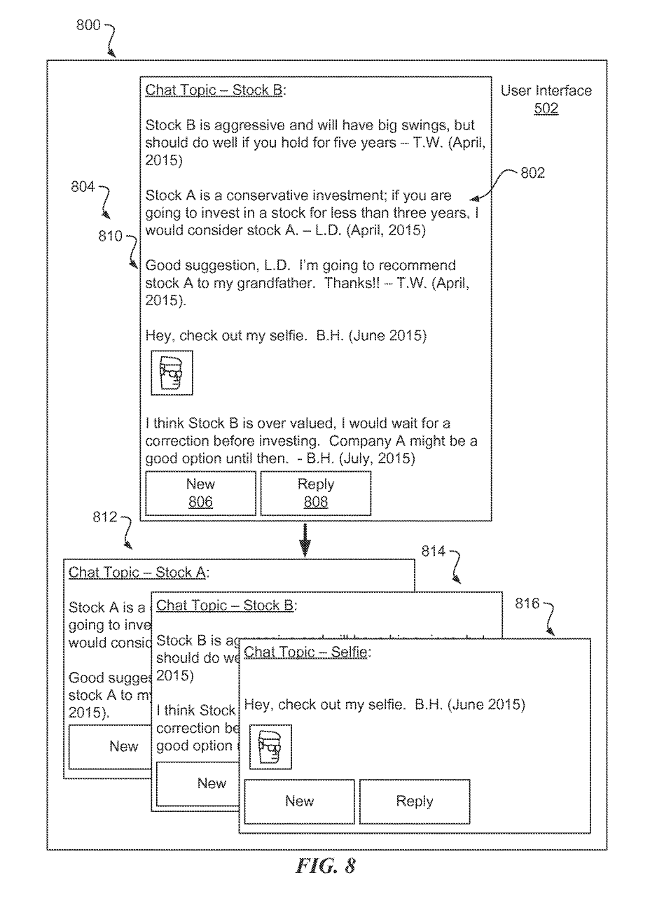

In the example of FIG. 8, a user of a multidimensional chat room system 800 may receive messages or chats that originate from another group member or remote user. Other group members can view and respond to the posts 802 in a conversation stream 804. In the multi-dimensional chat, the first user may have an option to choose between replying to the message or initiating a new topic in the post.

In some situations, the user can manually indicate that the new post contains a new subject to initiate a sub chat room (e.g. second conversation stream). For example, the user may select the new button 806 displayed in the user interface 502. In such an example, the user may be given the option to name the new topic, or add keywords or tags, or perform another function.

In other examples, to initiate the sub chat room, the user can merely type in a post that is dedicated to a new subject. In this example, a program may be used to search the post to determine whether the new post has a similar keyword or tag to the rest of the post or to whether the new post includes a new topic keyword or tag. Word recognition, time lapses between the previous and new post, the user submitting the new post, other types of factors, or combinations thereof may be used by the program to determine whether the new post includes a new subject. In such an example, the user may be given an option to name the new topic or the program may assign a new topic to the new post.

When the user decides to initiate a new topic, the conversation stream branches. When the conversation is branching, the multi-dimensional chat may separate into a main chat room 810 with at least one sub chat room 812. The present invention includes embodiments where both the main chat room 810 and the sub chat rooms 812, 814, 816 are displayed on the same page. Alternatively, the main chat and sub chats may be segregated to different pages. Such pages may be placed side by side, layered over one another with a selected chat being in the foreground of the screen and the unselected chats being in the background. In some cases, there can be an unlimited number of sub chat rooms where the sub chat room can be branched to another sub chat room, creating deeper dimensions, and vice versa. But, according to one example, a sub chat room can be substituted with a post, similar to the post 608, or with another module entirely.

In those examples where the user interface presents a new button 806 and a reply button 808, the user has an option to create a new topic or to reply to the current topic. When the user selects the reply button 818, the main chat room does not branch. But, when the user selects the new button 806, the main chat room branches and a new chat topic is created in a new sub-chat room. In some instances, the sub-chat and the main chat are included in the conversation stream. But, in other examples, new sub-chat rooms may be created for each of the different chat topics.

In some examples, when the main chat room creates a new branch, a noticeable space may be inserted between chats, which is usually larger than a space between the reply chats and/or posts. In another example, the main chat shows a line to separate between chats topics. In some examples, the chats with the same topic may be grouped together, be align to the left, be align to the right, appear in the same color, have a boundary around them, or have the same background color to distinguish the different chat topics.

According to another example, there may be just one new chat button incorporated into the main chat room. In such an example, the user may select the new button 806 just in those circumstances where a new topic is to be created. In the absences of selecting the new button 806, the chat system 800 may determine that the new post is intended to be included in the current chat discussion.

In some cases, each of the members of the main chat discussion will be invited to participate in each of the sub chat discussions. For example, when the new button 806 is selected, the main chat is broken into sub chat rooms, or provides notifications to all participates that new discussion is now created. According to another embodiment, the user may select between a new chat or a reply chat after the user has finished typing a message.

According to one embodiment, to reply to a much older chat, user can simply tap, swipe, or otherwise select the older chat. In some cases, the user may be redirected to that particular sub chat room page to continue chatting activities there. In other cases, the user can simply begin typing on the popped up textbox. In such an example, when the user is done the new reply chat appears just under the last reply chat in that particular conversation.

In some examples where the user is redirected to another sub chat room page, the user may be enabled to create new topic, which may create another sub chat room. Such a process may go on indefinitely creating multiple branches. In some cases, the new topic button may be disabled in the sub chat room. In other examples, when the user selects the new button 806 in a sub chat room, the user may be directed back to the main chat room and to create new chat topic there. In alternative embodiments, the user may create a new branch by selecting a new button 806 in the sub chat.

In some examples, a text box is provided to create a new topic. In such a situation, the user can type directly into the text box. Such a box may be located in any appropriate location in the user interface, including the bottom, sides, top, corners, and/or middle of the screen. Under some conditions, the user may respond as reply chat, by selecting any of previous chats or on the empty spaces to cause a pop up text box to appear. In some examples, to cancel the reply mode, the user may select an empty space where there is no chat or select a cancel button. This embodiment forces the user to be on the main chat room at all times and maintain a two dimensional chat system.

In another example, the participants may add their posts to the main chat page. To separate chats into a conversation group or multiple conversation groups, the user can insert conversation breakers. The command to add conversation breakers may be in response to selecting empty space in the screen, selecting a breaker button, or inputting another type of command. A conversation breaker may appear as a horizontal line across the page or the conversation breaker may as a larger space between posts. While these examples have been described with reference to specific ways to indicate different conversations, any appropriate conversation breaker indicator may be used.

In some examples, the user may insert items into the chat room, such as photos, maps, stickers, and the like. In some cases, the item may be considered as part of a new topic. Such an item may be functioned or featured like a traditional conversation stream in any social media, or it may be a sub chat room as explained previously. When a user inserts a post into a chat room, other users may comment on that item or create reply chats about that item. In some cases, an item may be used as an intuitive way to separate conversations in a chat room into sub topics, the users may reply to chats that are above an item, or to create new posts or reply chats that are below the item.

The items may include photos, maps, stickers, video, voice, links, uniform resource locators, other items, or combinations thereof. In some embodiments, all such items are considered to be new discussion topics. In an example where a photo is inserted into the conversation stream, the users adds more photos back to the same post even though the chats have already continued. As explained previously, the items may be added to earlier posts. Thus, such items may be archived with other posts of the subjects with like discussion topics.

In some cases, the user can convert a new topic post into a reply chat, or convert a reply chat into a new topic post. In some situations, a user may select multiple chats to create a reply chat or create a new sub chat room. Additionally, in other cases, a user may create a chat that is linked or referenced to a sub chat room page.

The multi-dimensional chat discussion cultivates the concept of chat grouping. The conversation, which includes new topic posts and multiple reply chats, can be archived in distinct groups. For example, each of the chats belonging to a first post can be stored together. In such an example, a user can pull up each of the conversation stream individually without have to search through the other conversation streams that are unrelated to the topic being searched. Such archived discussions may be transformed, shared, moved to other conversations, copied, pasted, or the like.

In some cases, the content of a chat may include a command key word. For instances, the command key word may include a cash tag for stock name, a number tag which may refer to a link of search page, a hyperlink when type “www” or another set of symbols are typed. Other key word commands may cause the insertion of a new stock chart, addition of a new stock to a portfolio, and the like. With this present invention, multidimensional chat system can support a large number of users, and conversations can be more organized and synchronized.

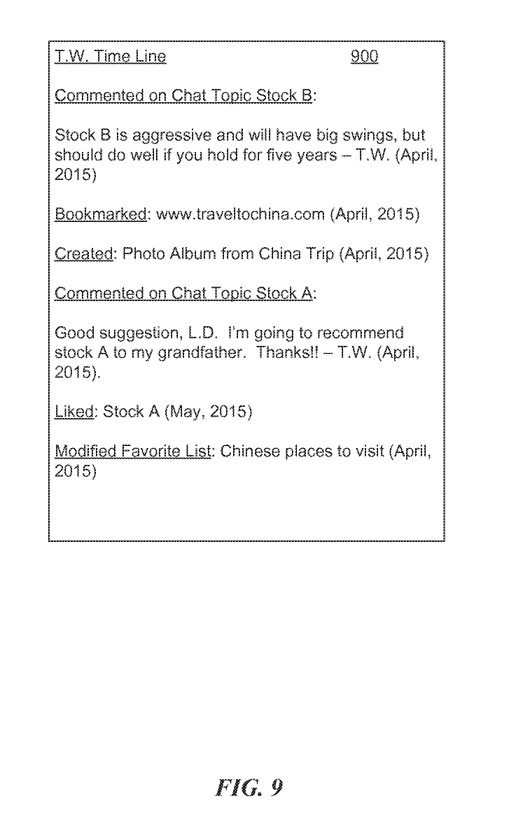

FIG. 9 depicts a system for presenting activities of a user or group with a social time line module integrated into the social media platform. According to one embodiment, a user may have one social time line 900 or a group can have one time line module. A user of a financial social media platform may choose to view a social time line module of another user or for a group in the social media platform. In the illustrated example, a list of the user's activities is depicted within the social media platform in a social time line mode. The time line may include a shared collection creation, comments, book markings, updates to shared collections, a post of comment in a chat room discussion, and other user activities. In some examples, other events not performed by the user or another group member may be recorded in the time line. For example, a module may add other events to the time line such as news module (e.g. news that was saved to be read or news that was read). The social time line module may be automatically generated based on the list of social activities, or users may create a post to the time line module. Each of these entries in the social time line may be referred to as a time line block. The list of time line blocks may be filtered. For example, the time line blocks may be filtered based on priority settings of the viewing user and/or privacy setting of the subject user. The list of time line blocks may be displayed as a list of items presented in a desired order (e.g. chronological, prioritized, alphabetical, and the like). Various time line block items in the social time line module may include a financial module, media content and/or links to media content such as bookmarks, maps, webpages, and so forth illustrating the activities of the subject user. The time line items may also include links to enable other group members to participate in the user's activities. The time line blocks may be automatically generated, periodically or real-time, based on the user's activity, such as creating a shared collection, commenting on a stock, liking a comment, posting a sticker, performing other activities, or combinations thereof. The social time line module may be updated by adding time line blocks about new activities and/or removing time line blocks about previous activities.

According to an embodiment, a time line block may be a sub chat room. Therefore as explained previously, user of the main chat room who wishes to reply to an old conversation may be redirected to a sub chat room which is a time line block and continue older conversation there. A time line block that is a sub chat room may include of a set of new topic chats and a set of the reply chats together in the form of a time line block. All chat rooms activities may be archived in this social time line module. In that sense, the social time line module may have all the conversations of the chat rooms and sub chat rooms that the user participates in.

In the present invention, a time line block can be optimized for social sharing. In such an example, the social features described above with relation to the collections, stocks, chat rooms, and so forth may be implemented in the social time line. A time line block can also associate with social information such as stickers, moods, like, opinion, comments, notes, and many more. Additionally, social information can be a summary of participates' moods, the popularities stock names, and etc., which can be generated from friends, the group, or the public.

In the present invention, a user can create any number of time line blocks, set permissions for other users, or invite other users for social relationships to grant them some permissions as described above. With proper permission, a user may copy and create new or shared time line blocks to a group time line module, or of a friend time line module, and so forth. In some cases, if a user shares a time line block with a time line group, the members of that group can view the time line block, but not edit the shared time line block based on his or her permissions. If, however, the user creates a time line block out of a group time line, the member may participate in editing and updating the time line block.

One of the advantages of the present invention is the integration of an activities stream (e.g. feed page, social wall page) with a social chat room, including the sub chat rooms, into a single page. In the conventional social media pages, that are single dimensional, the integration of each of these social media features would be overwhelming and difficult for users. But, with the multi-dimensional aspect of the time line described above where the different topics and items can be branched into smaller sub streams, a user can follow the different types of activities easier. In this present invention, the social time line module tracks the social activities that happen in the shared collection or the chat room and format this information in a social time line that is easier for the user to determine.

The social media system can create a library that collects the time line blocks that the user organized according to his or her preferences. Such a library can be named differently such as “Good books,” “Fundamental,” “Technical,” “My Past Stocks,” and so forth. A group or a user entity can create unlimited number of libraries to further organize time line blocks based on his or her desires.

In some examples, a user may create a custom stock/instrument symbol and associate symbol with information. A user or a group can collaborate in updating the information for such symbol. For instances, the symbol can be the price of oil in Utah, the price of gold bullion by a certain company, and the like. These custom instruments can be consumed as if they were a stock symbol from stock exchange. A user may further connect with an API to the financial social media platform and update the financial information automatically. Additionally, a user may indicate the source of data, such as a specific uniform resource locator, the specific position of the data on the webpage, and allow a financial social platform to periodically download, update, and/or synchronize the information automatically.

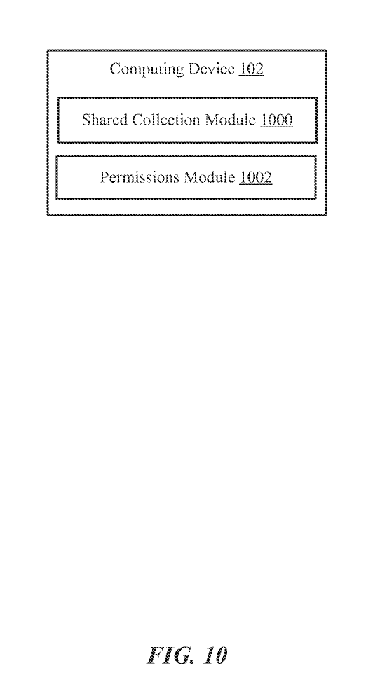

FIG. 10 is a block diagram illustrating one example of a computing device 102. In this example, the computing device 102 has a shared collection module 1000 and a permissions module 1002.

The computing device may be a computing device, such as the computing device 102 described in the environment of FIG. 1. Such a computing device 102 may host the social media platform on which the group members can create, edit, remove, update, maintain, copy, paste, sent, and otherwise interact with the shared collection, chat rooms, time line, other aspect of the social media platform, and so forth. Such a computing device 102 may be a desktop, a laptop, part of a network for hosting the social media platform, part of a datacenter, another type of computing device, or combinations thereof.

The shared collection module 1000 may execute the shared collection functions described above. A first user may use the social media platform to create shared collections and corresponding model profiles. Other group members can collaborate with the first user to keep the models information up-to-date. Additionally, the group members can annotate and comment on different parts of the shared collections.

The permissions module 1002 may control which group members can do certain tasks in the shared collections as described above. For example, some users may receive the ability to edit the shared collection, while others users may not. In another example, some users may have to access to view certain sensitive types of information while other group members do not. The level of permissions may be controlled based on a relationship with the first user who created the shared collection. The closest of such relationships may have access to the sensitive information or have the ability to edit, update, or remove information from the shared collection.

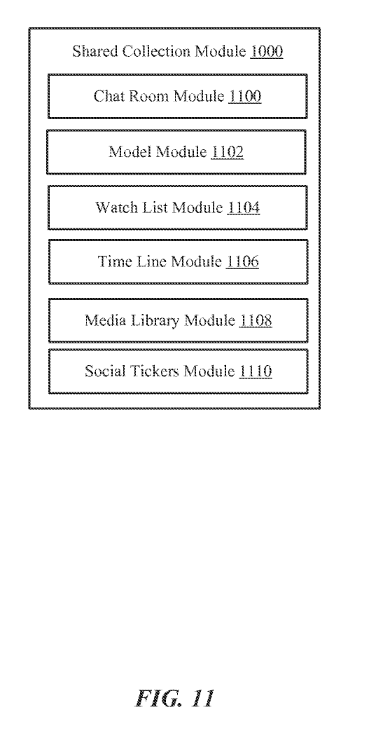

FIG. 11 is a block diagram illustrating one example of a shared collection module 1000. In this example, the shared collection module 1000 has a chat room module 1100, a model module 1102, a watch list module 1104, a time line module 1106, a media library module 1108, and a social tickers module 1110.

The chat room module 1100 may create a conversation stream in response to receiving posts from users. Chats may be added chronologically to the conversation stream. The initial post may include a topic identified by the first user. The subsequent chats may be presented in the conversation stream below the initial post when the subsequent chats include the same topic. But, in those circumstances where one of the group members indicates that the subsequent text and/or chat includes a different topic than the initial post, the chat room discussion branches. For example, when a subsequent chat is directed to a different topic, the text may be a post for a second conversation stream. Thus, the chat room module may track the first and second conversation streams simultaneously. These conversation streams may be viewed at the same time. Further, the conversation streams tie into each other. In some cases, the conversation streams are archived separately, but are depicted together in real time in the user interface.

The model module 1102 may include a module that allows a user to create, update, remove, and otherwise change model profiles. As the model profiles are changed, the copies of the models throughout the social media platform, including in the shared collections, are automatically updated so that the group members may interact with consistent and up-to-date information. Such a shared collection may be dedicated to a financial subject, in full or in part. In other examples, the shared collection is dedicated to other types of information than financial information.

The watch list module 1104 may be a shared collection that is created by a first user. This shared collection may include models that group members should watch or ought to consider watching. The list may include certain stocks, bonds, funds, money markets, retirement accounts, investor groups, other types of financial information, or combinations thereof. In other examples, such as a watch list may include non-financial information, such as a list of movies, professional sport teams, academics, politicians, other non-financial types of information, or combinations thereof. Based on the level of permissions that are given to the other group members, a group member may view, edit, modify, copy, paste, share, remove, maintain, update, or otherwise manipulate watch list by making the changes in the model profiles or direction to the shared collections. In some examples, the watch list may include sensitive information, which only certain group members have access. Such sensitive information may include financial account numbers, amounts in such accounts, other types of information, or combinations thereof.

The time line module 1106 may be a shared time line that is created by a first user. The time line may include a list of activities that have been performed by a user or the group members collectively. The time line may include certain information stocks, bonds, funds, money markets, retirement accounts, investor groups, other types of financial information, or combinations thereof. In other examples, the time line may include non-financial information, such as a list of movies, professional sport teams, academics, politicians, other non-financial types of information, or combinations thereof. The time line may include an activity stream that presents the times that the groups participated in certain activities. For example, when a user creates a shared collection, such an event may be recorded in the time line. Likewise, when a user makes a comment about a shared collection or contributes to a chat room discussion, such events may be recorded in the time line. Like the other types of shared collaborations described above, a first user may create the time line. Based on the level of permissions that are given to the other group members, a group member may view, edit, modify, copy, paste, share, remove, maintain, update, or otherwise manipulate the time line. In some examples, the time line may include sensitive information, which only certain group members have access to. Such sensitive information may include financial account numbers, amounts in such accounts, other types of information, or combinations thereof.

The shared media library module 1108 may be a shared library that contains the media used by the group members. For example, the library may contain the photos, videos, charts, links, audio files, images, other items, or combinations thereof that have been incorporated into the other group collaborations described above. Based on the level of permissions that are given to the other group members, a group member may view, edit, modify, copy, paste, share, remove, maintain, update, or otherwise manipulate the items in the library. In some examples, the media library may include sensitive information, which only certain group members have access to. Such sensitive information may include financial account numbers, amounts in such accounts, other types of information, or combinations thereof.

The social tickers module 1110 may include the hardware and programmed instructions necessary to send to at least one group member information from outside sources that can be used to update, improve, maintain, and so forth any of the group collaborations described above. For example, a social ticker may send the end of day trading information to a group member, which a group member can use to update a shared financial collection. Such a group member may be the first user who created the collection, but in alternative examples, such a user is another user that has permissions to edit, update, or otherwise make changes to the shared collection.

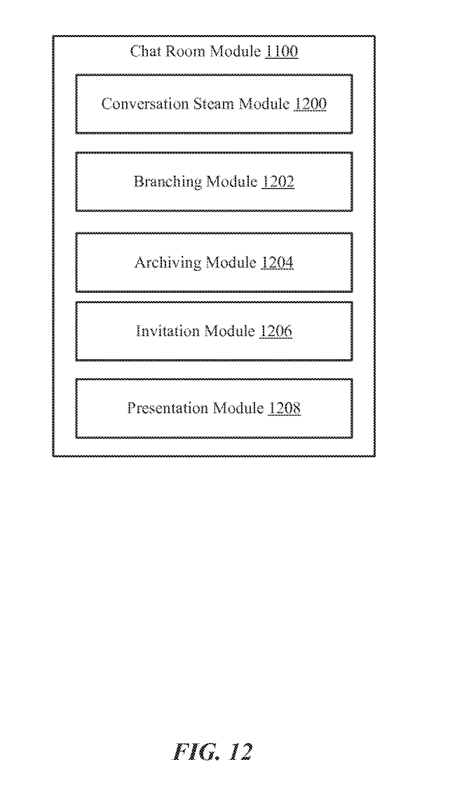

FIG. 12 depicts an example of a chat room module 1100. In this example, the chat room module includes a conversation stream module 1200, a branching module 1202, an archiving module 1204, an invitation module 1206, and a presentation module 1208.

The conversation stream module 1200 may cause the chats made by group members to be inserted into a conversation stream based on the chats and texts received by group users. Such conversation streams may be initiated with a post, but subsequent chats may be inserted into the appropriate conversation stream. Such chats may be inserted in chronological order based on the order that the chats were received in the absence of instructions to do otherwise.

The branching module 1202 may determine the topic of the chats inserted into the conversation stream. In the event, that the topic of the chats is different in a than the topic of the conversation stream, the branching module may send an instruction to create a new conversation stream with the text or chat with the different topic as the initial post in the new conversation stream. In some examples, the branching module receives information from buttons selected by the user about the topic of the chats and/or texts inserted into the conversation stream. Such buttons may be selected by the user to indicate whether the subject of the added chat has the same subject or a different subject than the current conversation stream. If the selected button indicates that the topic is the same as the current conversation stream, then the branching module can insert the into the current conversation stream. On the other hand, if the selection of the buttons indicate that the topic is different, then the branching module may cause the conversation to be branched by creating a new conversation stream (or referenced to as a sub chat room in the description above). In other examples, the branching module determines the topics based on information that the branching module analyzes within the chats and texts. For example, the branching module may analyze the key words in the chat, the key word density in the chats, other factors, or combinations thereof. In some examples, an item inserted into the conversation stream may be considered by default to have a different topic. For example, an image inserted into a conversation stream may trigger a response from the branching module to create a new conversation stream.

The archiving module 1204 may create an easy to follow archiving structure to retrieve and/or review the different conversation streams. In some examples, the archiving module causes each separate conversation streams to be stored independently of the other conversation streams. As the conversations streams are branched, the archiving module may store each conversation stream independently in real time. Thus, as new comments are added to the conversations streams, the archiving module adds each chat to the archived conversation streams. In some circumstances, the archived conversation streams are duplicates of conversation streams presented in the user interface. The user interface may present the conversation streams simultaneously (e.g. layered format, side by side format, grouped format, another type of format, or combinations thereof). In those circumstances where a user desires to search a conversation stream, the user may pull up just the archived conversation stream without having to sort through the other topics that were presented.

For example, if the user is just interested in chats that a user made about his trip to France, the user can pull of the archived conversation stream dedicate to chats about the trip to France even through the chats about the trip were initially made when the users were discussing a financial topic. While the branching module is organized to show how the chats about the trip to France were injected into the conversation about the financial topic, the archived conversation about France excludes the information about the financial topic and, thus, presents just the information of interest to the user.

The invitation module 1206 may cause invitations or alerts to be sent to the group members participating in the first conversation stream that is dedicated to a first topic to join the second conversation stream dedicated to a second topic. In some examples, the participates of the first conversation stream may not be interested in joining the second conversation stream, so they may opt out of being joining. In following the example from above where one conversation streams is dedicated to a financial topic and the other to a trip, if one of the participants does not want to see or be part of the discussion about the trip to France, the user interface may only present to that participant the added chats about the financial topic while others can view both conversations. In some examples where the new topic involves sensitive information, only those members that have permissions to view such sensitive information may be invited to the join the second conversation stream.

The presentation module 1208 may allow a user to view the multiple chat room discussions at the same time. In some examples, the search module presents the various conversation streams in the user interface at the same time so that the user can see the different topics. Such a presentation may include displaying the conversation stream side by side. In other examples, the conversation stream may be layered on top of one another.

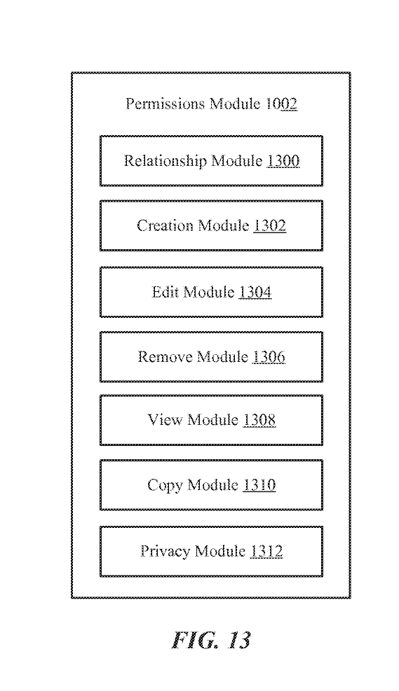

FIG. 13 depicts an example of the permissions module 1002. In this example, the permissions module 1002 may include a relationship module 1300, a creation module 1302, an edit module 1304, a remove module 1306, a view module 1308, a copy module 1310, and a privacy module.

The relationship module 1300 may cause certain group members to receive certain types of permissions based on their relationship with the user who created the shared collections. Such a relationship may be included in the user's profile. In some examples, the relationship is a family member, a spouse, a business partner, a fiduciary, a board member, another type of relationship, or combinations thereof. In other examples, the relationship is based on the number of degrees a person is removed from the first user.

The creation module 1302 may grant a user permission to create a shared collection. The edit module 1304 may grant a user permission to edit a shared collection. The remove module 1306 may grant a user permission to remove an entire shared collection or just one of the models. The view module 1308 may grant a user permission to view a shared collection. The copy module 1310 may grant a user permission to copy at least a portion of the shared collection. In some examples, these types of permissions may be automatically granted to the user that creates the shared collection. In other examples, these permissions are granted to other group members who did not create the shared collection.

The privacy module 1312 may grant the user an ability to see certain types of sensitive information that the other group members cannot see. Such private information may include account information (e.g. names and amounts), other financial assets, other types of information, or combinations thereof. Such a permission may be granted based on the group member's relationship with the user who created the shared collection.

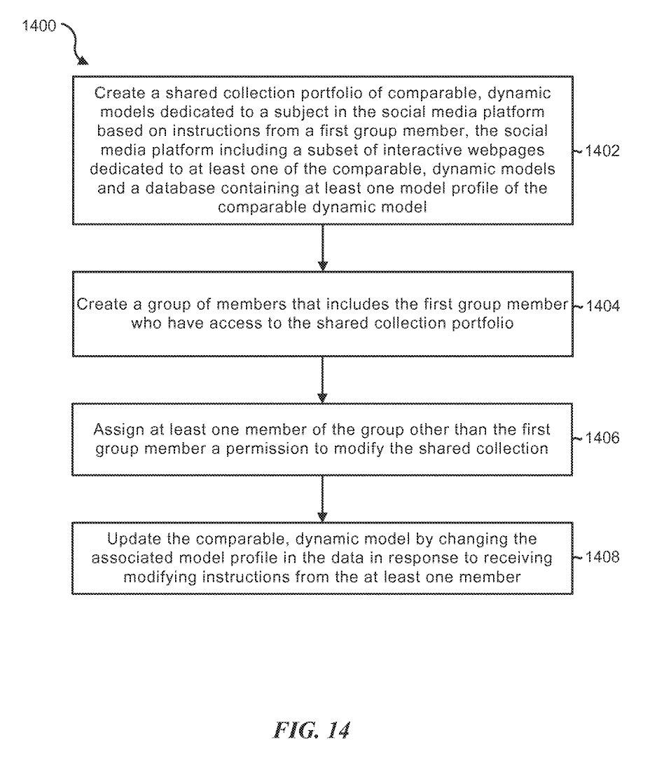

FIG. 14 is a flow diagram illustrating an example of a method 1400 for managing dynamic models in a social media platform accordance to the principles described in the present disclosure. In this example, the method 1400 includes creating a shared collection of comparable, dynamic models dedicated to a subject in the social media platform based on instructions from a first group member, the social media platform including a subset of interactive webpages dedicated to at least one of the comparable, dynamic models and a database containing at least one model profile of the comparable dynamic model; creating a group of members that includes the first group member who have access to the shared collection; assigning at least one member of the group other than the first group member a permission to modify the shared collection; and updating the comparable, dynamic model by changing the associated model profile in the data in response to receiving modifying instructions from the member.

At block 1402, a shared collection is created. The shared collection includes at least one dynamic model. The shared collection provides a platform where the dynamic models can be compared to one another. Thus, dynamic models can be compared to each other in a group of interactive webpages of the social media platform. The shared collection is dedicated to a single subject making the models easier to compare. The comparable, dynamic models are associated with model profiles that are stored in a database. As the model profiles are updated either automatically or manually, the models in the interactive webpages are also updated to be consistent with what is contained in the model profiles.

At block 1404, a group of members is created. The group of members includes the first member who created the shared collection. These members may be members who already have a user profile in the social media platform. Each of the members may include a user profile that contains information about the user as well as a relationship with the first group member.

At block 1406, at least one member of the group other than the first member is assigned a permission to modify the shared collection. The permission may include an ability to edit, remove, create, annotate, comment on, or perform another type of function to the shared collection and/or to one of the model profiles in the shared collection.

At block 1408, the comparable, dynamic model is updated by changing the associated model profile in the data in response to receiving modifying instructions from the member who has permissions. Such modifying instructions may include commands to edit, remove, create, annotate, comment on, or perform another type of function to shared collection and/or model profiles.

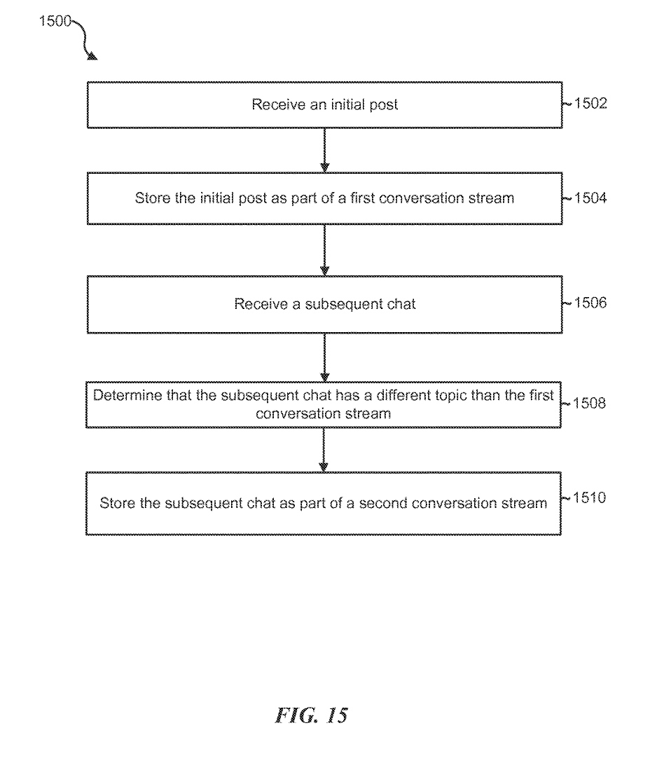

FIG. 15 is a flow diagram illustrating an example of a method 1500 for branching conversation stream accordance to the principles described in the present disclosure. In this example, the method 1500 includes receiving 1502 an initial post, storing 1504 the initial post as part of a first conversation stream, receiving 1506 a subsequent chat, determining 1508 that the subsequent chat has a different topic than the first conversation stream, and storing 1510 the subsequent chat as part of a second conversation stream.

At block 1502, an initial post is received. At block 1504, the initial post is stored in a first conversation stream. Such a conversation stream may be visible in the user interface of a client device at the same time that the first conversation stream is visible. In other examples, the conversation stream is not visible at the same time. At block 1506, a subsequent chat is received. The subsequent chat may be sent from the same user that sent the initial post or it may be sent by another group member. At block 1508, the subsequent chat is determined to have a different topic than the first conversation stream, and at block 1510 the subsequent chat is stored in a second conversation stream. In some cases, both of the conversation stream are displayed simultaneously in the user interface. Thus, a user can view each of the conversation stream at once. The subsequent chat may be added to the second conversation stream just in those cases where the subsequent chat has a different topic than the initial conversation stream.

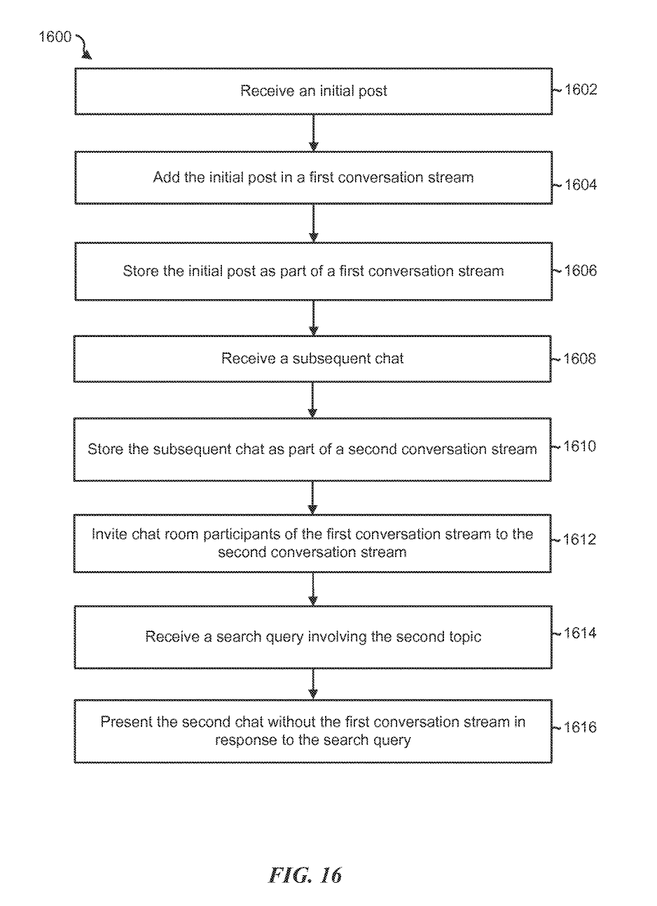

FIG. 16 is a flow diagram illustrating an example of a method 1600 for branching conversation streams accordance to the principles described in the present disclosure. In this example, the method 1600 includes receiving 1602 an initial post, adding 1604 the initial post in a first conversation stream, storing 1606 the initial post as part of a first conversation stream, receiving 1608 a subsequent chat, storing 1610 the subsequent chat as part of a second conversation stream, inviting 1612 chat room participants of the first conversation stream to the second conversation stream, receive 1614 a search query involving the second topic, and presenting 1616 the second archived conversation stream without the first conversation stream in response to the search query.

At block 1612, members of the chat room discussion may be invited to be part of the second conversation stream. For instance, all of the posts relating to the first topic may be added to the first conversation stream while all of the posts relating to the second topic may be added to the second chat. Thus, the participants that are involved with the first chat topic may be invited to participate in the second chat topic.

At block 1614, a search query is received that involves the second topic. At block 1616, the second chat is presented with the first chat in response to the search query. In such an instance, the posts of the first conversation stream do not include the second topic, so the first conversation stream is not displayed as part of the search query.

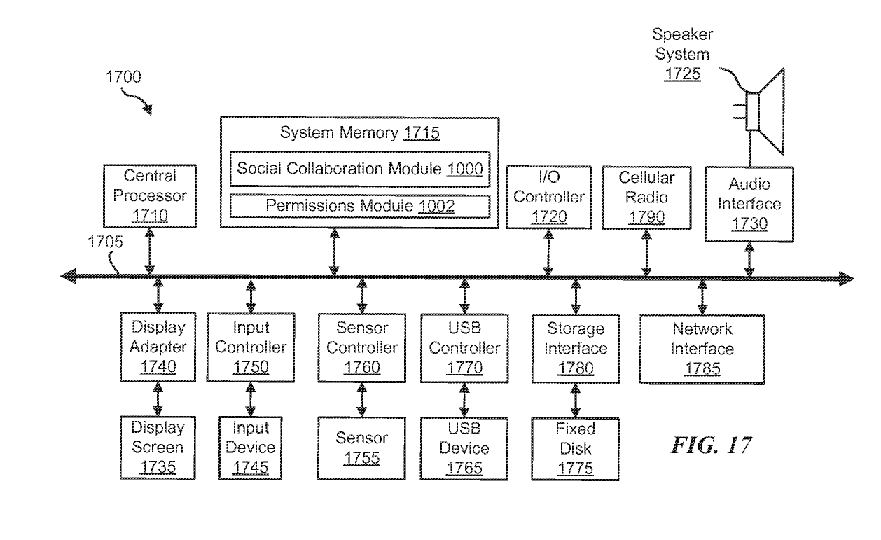

FIG. 17 depicts a block diagram of a controller 1700 suitable for implementing the present systems and methods. The controller 1700 may be an example of the computing device 102 in FIG. 1. In one configuration, controller 1700 includes a bus 1705 which interconnects major subsystems of controller 1700, such as a central processor 1710, a system memory 1715 (typically RAM, but which may also include ROM, flash RAM, or the like), an input/output controller 1720, an external audio device, such as a speaker system 1725 via an audio output interface 1730, an external device, such as a display screen 1735 via display adapter 1740, an input device 1745 (e.g., remote control device interfaced with an input controller 1750), multiple USB devices 1765 (interfaced with a USB controller 1770), one or more cellular radios 1790, and a storage interface 1780. Also included are at least one sensor 1755 connected to bus 1705 through a sensor controller 1760 and a network interface 1785 (coupled directly to bus 1705).

Bus 1705 allows data communication between central processor 1710 and system memory 1715, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components or devices. For example, a shared collection module 1000 or a permissions module 1002 may be used to implement the present systems and methods may be stored within the system memory 1715. These modules may be an example of the modules illustrated in FIG. 10. Applications resident with controller 1700 are generally stored on and accessed via a non-transitory computer readable medium, such as a hard disk drive (e.g., fixed disk 1775) or other storage medium. Additionally, applications can be in the form of electronic signals modulated in accordance with the application and data communication technology when accessed via network interface 1785.

Storage interface 1780, as with the other storage interfaces of controller 1700, can connect to a standard computer readable medium for storage and/or retrieval of information, such as a fixed disk drive 1775. Fixed disk drive 1775 may be a part of controller 1700 or may be separate and accessed through other interface systems. Model database 112 stores the profiles of each models. Network interface 1785 may provide a direct connection to a remote server via a direct network link to the Internet via a POP (point of presence). Network interface 1785 may provide such connection using wireless techniques, including digital cellular telephone connection, Cellular Digital Packet Data (CDPD) connection, digital satellite data connection, or the like. In some embodiments, one or more sensors (e.g., motion sensor, smoke sensor, glass break sensor, door sensor, window sensor, carbon monoxide sensor, and the like) connect to controller 1700 wirelessly via network interface 1785. In one configuration, the cellular radio 1790 may include a receiver and transmitter to wirelessly receive and transmit communications via, for example, a cellular network.

Many other devices or subsystems (not shown) may be connected in a similar manner (e.g., entertainment system, computing device, remote cameras, wireless key fob, wall mounted user interface device, cell radio module, battery, alarm siren, door lock, lighting system, thermostat, home appliance monitor, utility equipment monitor, and so on). Conversely, all of the devices shown in FIG. 17 need not be present to practice the present systems and methods. The devices and subsystems can be interconnected in different ways from that shown in FIG. 17. The aspect of some operations of a system such as that shown in FIG. 17 are readily known in the art and are not discussed in detail in this application. Code to implement the present disclosure can be stored in a non-transitory computer-readable medium such as one or more of system memory 1715 or fixed disk 1775. The operating system provided on controller 1700 may be iOS®, ANDROID®, MS-DOS® MS-WINDOWS®, OS/2®, UNIX®, LINUX®, or another known operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present systems and methods may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

Furthermore, while various embodiments have been described and/or illustrated herein in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of” In addition, for ease of use, the words “including” and “having,” as used in the specification and claims, are interchangeable with and have the same meaning as the word “comprising.” In addition, the term “based on” as used in the specification and the claims is to be construed as meaning “based at least upon.”

What is claimed is:

1. A method for managing dynamic models in a social media platform, comprising:
creating a shared collection of comparable, dynamic models dedicated to a subject in the social media platform based on instructions from a first group member, the social media platform including a subset of interactive webpages dedicated to at least one of the comparable, dynamic models and a database containing at least one model profile of the comparable, dynamic models;
creating a group of members that includes the first group member who have access to the shared collection;
assigning at least one member of the group other than the first group member a permission to modify the shared collection; and
updating the comparable, dynamic models by changing the associated model profile in the database in response to receiving modifying instructions from the at least one member.

2. The method of claim 1, wherein the at least one of the comparable, dynamic models is a financial asset.

3. The method of claim 1, wherein the at least one of the comparable, dynamic models is a commercial product.

4. The method of claim 1, wherein the at least one of the comparable, dynamic models is a service.

5. The method of claim 1, wherein the permission includes an ability to create a new model profile in the database through the subset of interactive webpages.

6. The method of claim 1, wherein the permission includes an ability to edit the associated model profile in the database through the subset of interactive webpages.

7. The method of claim 1, wherein the permission includes an ability to remove an existing model profile from the shared collection.

8. The method of claim 1, wherein the permission includes an ability to annotate an existing model within the shared collection.

9. The method of claim 1, further comprising withholding the permission from another member of the group.

10. The method of claim 1, further comprising determining to assign at least one member of the group the permission to modify based on at least one criteria.

11. The method of claim 10, wherein the at least one criteria is a family relationship identified in a user profile.

12. The method of claim 10, wherein the at least one criteria is a degree of separation relationship identified in a user profile.

13. The method of claim 10, wherein the at least one criteria is an organization membership relationship identified in a user profile.

14. The method of claim 1, further comprising granting access to private information in the shared collection to a designated member so that the designated member has an ability to view the private information while non-designated members have just access to public information in the shared collection.

15. The method of claim 1, further comprising sharing the shared collection publically so that non-members have access to public information in the shared collection while at least designated members of the group have access to public information and private information.

16. A system, comprising:
a social media platform, the social media platform, comprising:
a group members, each of the group members having a user profile;
a shared collection of comparable, dynamic models dedicated to a subject;
the shared collection has a subset of interactive webpages dedicated to at least one of the comparable, dynamic models; and
a database containing a model profile for the at least one of the comparable, dynamic models that is linked to a subset of webpages;
wherein an update to the model profile is reflected in the subset of webpages.

17. The method of claim 1, wherein the at least one of the comparable, dynamic models is a financial asset.

18. The method of claim 1, wherein the at least one of the comparable, dynamic models is a commercial product.

19. The method of claim 1, wherein the at least one of the comparable, dynamic models is a service.

20. A system, comprising:
a social media platform, the social media platform, comprising:
a group members, each of the group members having a user profile;
a shared collection of comparable, dynamic financial assets dedicated to a subject where the shared collection is created by a first member of the group members;
the shared collection has a subset of interactive webpages dedicated to at least one of the comparable, dynamic financial assets; and
a database containing a model profile for the at least one of the comparable, dynamic models that is linked to the subset of webpages;
wherein an update to the model profile is reflected in the subset of webpages;
wherein other group members in addition to the first member have an ability to send modifying instructions to update the model profile, to create a new model profile, and to remove the model profile.
